(19) United States
(12) Patent Application Publication
(10) Pub. No.: US 2022/0391974 A1
(43) Pub. Date: Dec. 8, 2022

(54) RESIDENT DATA MANAGEMENT SYSTEM AND METHOD

(71) Applicant: Esusu Financial Inc, New York, NY (US)

(72) Inventors: Wemimo Abbey, Los Angeles, CA (US); Samir Goel, New York, NY (US); Robert Henning, New York, NY (US); Albert Owusu-Asare, New York, NY (US); Ameer Shujjah, Islamabad (PK); Meghashree Manjunath, Dallas, TX (US); Ben Braunstein, Great Neck, NY (US); Alan James, Sandford, FL (US); Nqobile Chitimbire, Kew Gardens, NY (US); Carmela Peroff, Chanhassen, MN (US)

(21) Appl. No.: 17/834,700

(22) Filed: Jun. 7, 2022

Related U.S. Application Data
(60) Provisional application No. 63/208,021, filed on Jun. 8, 2021.

(51) Int. Cl. G06Q 40/02; G06Q 50/16

(52) U.S. Cl. CPC G06Q 40/025; G06Q 50/163

(57) ABSTRACT

A method, system, and computing capabilities are presented for improving visibility to resident payment trends, resident credit score trends, and anticipated rent income trends. A rent payment risk level of individual residents is evaluated based upon credit scores and historic rent payment information of residents. Resident risk evaluations are aggregated, producing a property stability score. Resident rent payment information may be provided to credit bureaus for incorporating into individual credit scores. High risk residents may be advised of financing options that are suitable for their needs.

### CROSS-REFERENCE TO RELATED APPLICATIONS

This application claims priority to and the benefit of U.S. provisional application Ser. No. 63/208,021 filed on Jun. 8, 2021 and entitled TENANT DATA MANAGEMENT SYSTEM AND METHOD, which is commonly assigned and the contents of which are expressly incorporated herein by reference.

### FIELD

The present invention relates to resident data management. More particularly, the present invention relates to an improved system, methods, and computing capabilities that provide resident payment risk profiles regarding properties and communicate resident payment activity to credit bureaus.

### BACKGROUND

Many landlords and property managers undertake resident screening before admitting a new resident into a unit. This screening often involves a credit score check at a specific point in time. Once a resident has been admitted into a property, most property managers and landlords have very little visibility into the financial well-being of that resident. When a resident experiences a serious financial setback, the property manager or landlord only finds out when the resident starts paying rent late or stops paying altogether.

This lack of insight extends across entire property portfolios. Property managers and landlords have no predictive way of knowing how vulnerable their overall rental income streams are to erosion or disruption. Managers and landlords simply operate in an environment where they can only respond reactively to income stream shocks.

The lack of anticipated rental income visibility and reliable predictability gives rise to several challenges. These challenges include potential disruption of cash flow for the property, which can be devastating to its ongoing operations. These challenges also include an inability to accurately factor in rental income reliability for property valuations. For example, uncertainty relating to rental income creates uncertainty with respect to the overall value and future value of a rental property. This can inhibit the ability to market and sell a rental property and inhibit the availability of credit and investor capital.

Additionally, exemplary embodiments of the present invention may optionally provide lenders who extend credit and capital to property owners real-time visibility of resident credit health and cash flow information relating to the property portfolios of entities that they have an interest or stake in.

Similarly, secondary mortgage market lenders (SMML) also have a keen interest in resident credit health and trends. These entities are increasingly factoring in the Environmental, Social, and Governance (ESG) impact when making mortgage acquisition decisions. Improvements in resident credit scores are a significant factor for evaluating ESG.

What is needed are especially efficient and effective systems, methods, and computing capabilities that provide property owners and managers, lenders, and SMMLs with proactive visibility to, and reliable predictions of, rental income streams as well as resident credit status and trends. In addition, it is especially beneficial if the system, methods, and computing capabilities also integrate a resident's rent payment activities into that individual's credit bureau credit score. For example, when a resident consistently pays rent on time, it is helpful when that behavior positively influences the individual's credit score. This benefits not only the individual but also the landlord because the individual is incentivized and more motivated to consistently pay rent on time. Additionally, there is a substantial benefit when the system, methods, and computing capability identify residents at risk of not paying rent timely, and can connect residents with fair, low-interest lending sources to support their financial needs. Also, resident credit status and trends are of particular interest to the SMMLs.

### SUMMARY

In an exemplary embodiment of the present invention, a computer network implemented method for resident data management comprises periodically executing a scheduled retrieval of resident activity information for a plurality of residents over the internet from at least one property management software platform. The resident activity information is stored in at least a first digital database. In an exemplary embodiment, property managers may also or alternatively upload data through a secure portal.

The method also periodically executes a scheduled retrieval over the internet of resident credit score information for the plurality of residents and stores the resident credit score information in a second digital database. The method calculates a resident risk score for each of the plurality of residents based upon the resident activity information and the resident credit score information. The method also aggregates the resident risk score information from a particular property location and generates a property stability score.

The exemplary method provides a browser-based client user interface. In response to a client user query, the property stability score is transmitted to the client user interface for display.

The method also compiles a plurality of resident credit score updates for each of the plurality of residents based upon the resident activity information. The method periodically executes a scheduled transmission of the plurality of resident credit score updates to a credit bureau.

Additionally, in response to a respective resident credit score request, the credit score is transmitted to the respective one of the plurality of residents.

In another exemplary embodiment of the present invention, a computer network implemented method for resident data management comprises retrieving resident activity information for a plurality of residents over the internet from at least one property management software platform. The resident activity information is stored in at least a first digital database.

The method also retrieves over the internet resident credit score information for the plurality of residents. The resident credit score information is stored in a second digital database.

The method calculates a resident risk score for each of the plurality of residents based upon the resident activity information and the resident credit score information. The method also aggregates the resident risk score information to generate a property stability score.

The method provides a browser-based client user interface and transmits the property stability score to the client user interface for display.

An additional exemplary embodiment of the invention comprises a non-transitory computer-readable medium storing a program that, when executed by a computer system comprising one or more processors, causes the computer system to perform a method for resident data management. The method comprises retrieving resident activity information for a plurality of residents over the internet from at least one property management software platform. The resident activity information is stored in at least a first digital database. Resident credit score information for the plurality of residents is retrieved over the internet. The resident credit score information is stored in a second digital database.

A resident risk score for each of the plurality of residents is calculated based upon the resident activity information and the resident credit score information. The resident risk score information is aggregated to generate a property stability score. A browser-based client user interface is provided, and the property stability score is transmitted to the client user interface for display.

### BRIEF DESCRIPTION OF DRAWINGS

These and other features, aspects, and advantages of the present invention will become better understood with regard to the following descriptions, claims, and accompanying drawings. It is to be noted, however, that the drawings illustrate only several embodiments of the invention and are therefore not to be considered limiting of the invention's scope as it can admit to other equally effective embodiments.

FIG. 1 is a block diagram of a resident data management system according to one exemplary embodiment of the present invention.

FIG. 2 is a block diagram illustrating retrieving and storing resident activity information according to one exemplary embodiment of the present invention.

FIG. 3 is a block diagram illustrating retrieving and storing resident credit score information according to one exemplary embodiment of the present invention.

FIG. 4 is a block diagram illustrating compiling resident credit score updates and providing resident credit score updates to credit bureaus according to one exemplary embodiment of the present invention.

FIG. 5 is a block diagram illustrating aggregating resident risk score information to generate a property stability score and providing the property stability score for display on a client user interface, and illustrating communicating information of interest to a resident user interface, according to one exemplary embodiment of the present invention.

FIG. 6 illustrates a client user interface display tailored for a property owner according to one exemplary embodiment of the present invention.

FIG. 7 illustrates a client user interface display tailored for a lending institution according to one exemplary embodiment of the present invention.

FIG. 8 illustrates a client user interface display tailored for a Secondary Mortgage Market Lender according to one exemplary embodiment of the present invention.

FIG. 9 is a flowchart illustrating a method of resident data management according to one exemplary embodiment of the present invention.

FIG. 10 illustrates a non-transitory computer readable medium storing a program that, when executed by a computer system comprising one or more processors, causes the computer system to perform a method for resident data management according to one exemplary embodiment of the present invention.

### DETAILED DESCRIPTION

So that the manner in which the features and advantages of embodiments of methods and systems of the present invention may be understood in more detail, a more particular description of the present invention briefly summarized above may be had by reference to certain embodiments thereof that are illustrated in the appended drawings, which form a part of this specification. The drawings illustrate only certain embodiments of the present invention and are, therefore, not to be considered limiting of the scope of the present invention which includes other useful and effective embodiments as well.

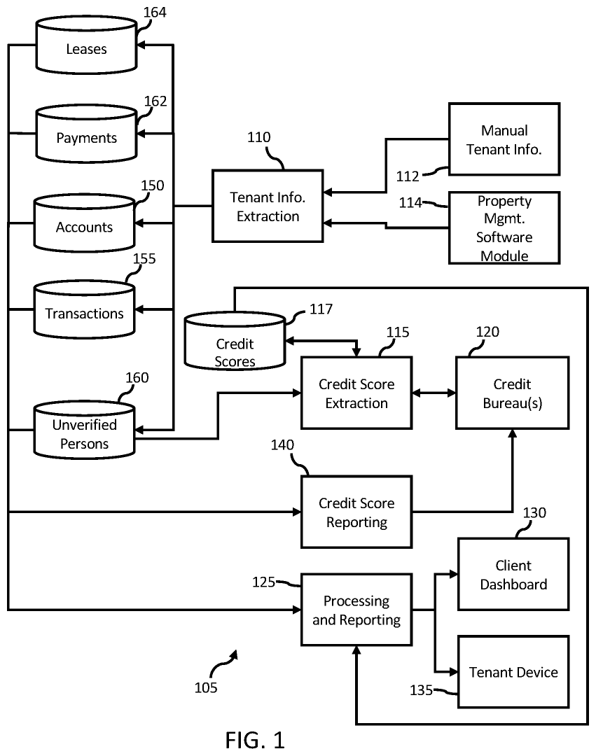

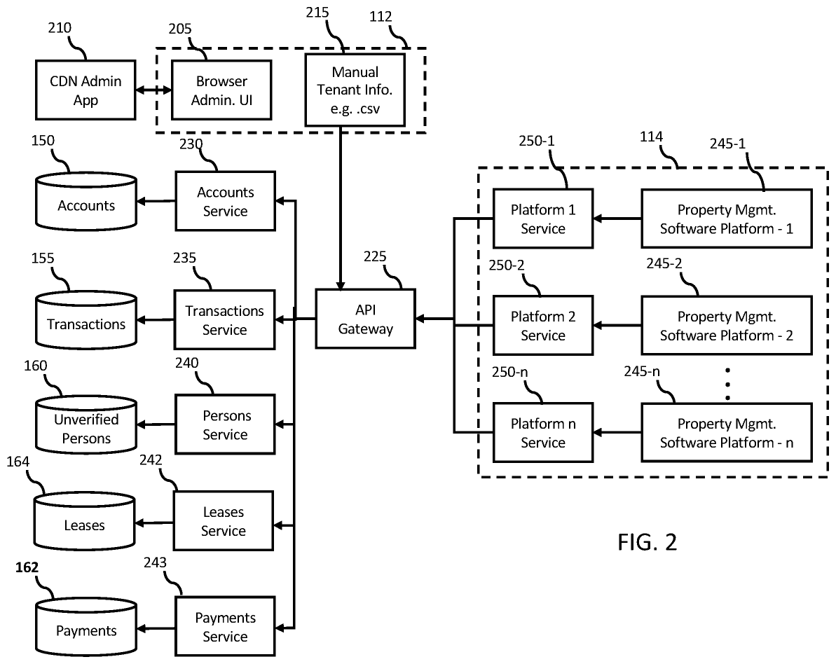

FIG. 1 is a block diagram of a resident data management system according to one exemplary embodiment of the present invention. The exemplary system and method are described here first at a high level. The inventive method operates an innovative computer based digital system 105. The system includes but is not limited to software modules, network connections, and data storage. System 105 collects resident activity data including rent payment or non-payment, by way of software module 110. The resident activity data is collected either by way of a manual process involving manual resident information software module 112, or by input from property management software module 114, or both. Each of module 112 and 114 will be described in more detail below, with reference to FIG. 2.

System 105 collects resident credit score information by way of credit score extraction software module 115. In the exemplary embodiment, the credit score information is the traditional credit score that is available from credit bureaus such as Equifax, represented by credit bureau 120. Credit scores and associated resident information are stored in credit scores digital database 117.

In the exemplary embodiment, a resident risk score is calculated for each resident based upon the resident's activity data and history and the resident's credit score. Note that, as described in more detail below, any resident can opt out of having her or his data collected and used for making calculations.

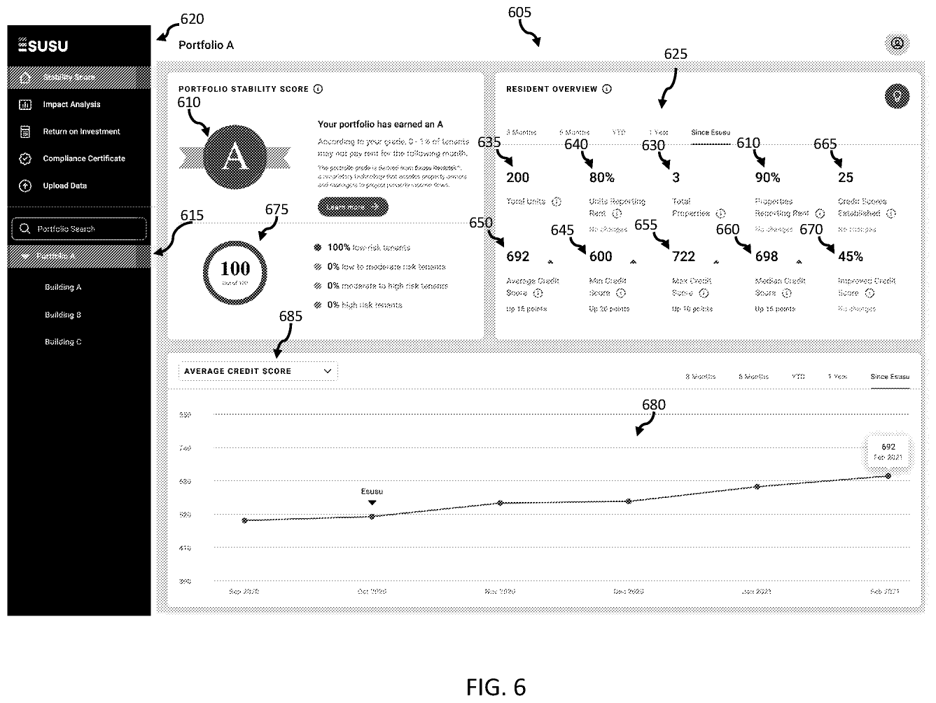

The resident risk scores are aggregated by processing and reporting software module 125, generating a property stability score. In certain embodiments, the property stability score and associated data are transmitted for display to client dashboard software module 130. In certain embodiments, client dashboard software module 130 is tailored to display information most useful to the property managers and property owners. An exemplary property owner dashboard is illustrated by FIG. 6, discussed in further detail below.

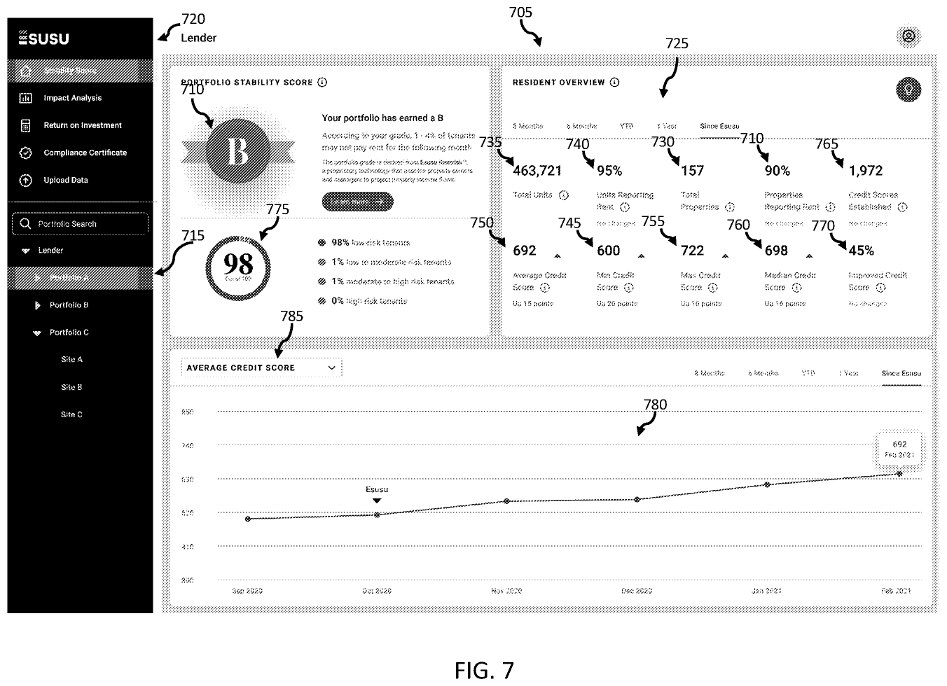

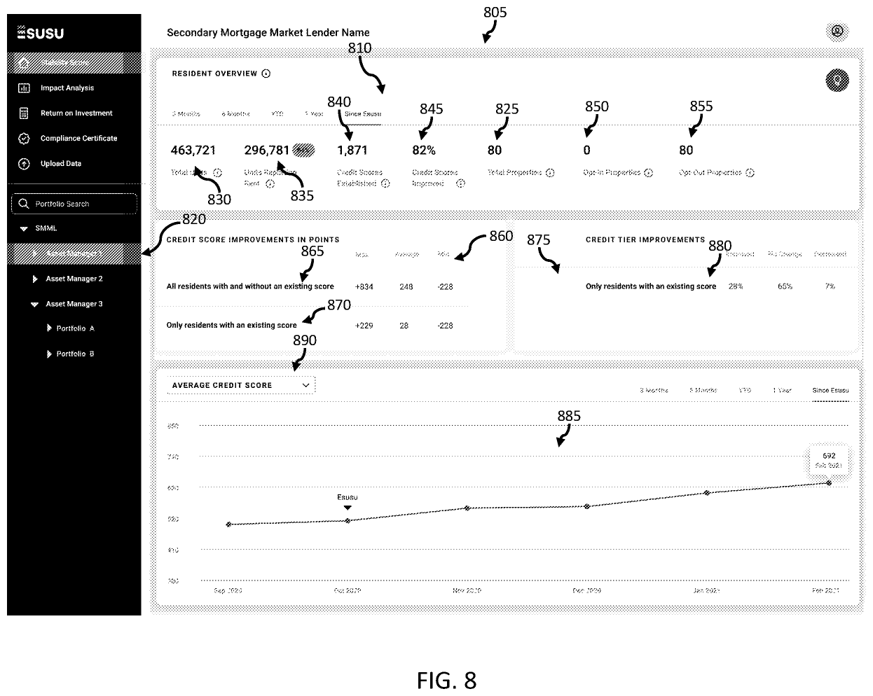

In other embodiments client dashboard software module 130 may be tailored to include information most useful to lenders that have provided or are considering extending credit and capital investments to property owners. An exemplary lender dashboard is illustrated by FIG. 7, discussed in further detail below. In additional embodiments client dashboard software module 130 may be tailored to include information most useful to SMMLs that are interested in data relevant to mortgage purchase decisions and to the Environmental, Social, and Governance status of property portfolios. An exemplary SMML dashboard is illustrated by FIG. 8, discussed in further detail below. Additionally, information, such as recent credit scores, can be communicated to residents by way of processing and reporting module 125 transmitting that information to a resident device 135, which may be, as examples, a smartphone, tablet, or laptop computer.

In an exemplary embodiment, the resident risk scores are categorized into four risk level tiers, referred to as low risk, low_moderate risk, moderate_high risk, and high risk. In an exemplary embodiment, the respective risk levels are calculated based upon the factors of (i) past due balance, if any, (ii) outstanding not-past-due balance, if any, (iii) monthly rent amount, and (iv) resident's credit score. Thresholds for these values, and combinations of these values, may be set so as to categorize residents into four different risk levels, according to the risk tolerance of the system designer and/or system user.

In an exemplary embodiment, the property stability score is reflected in a letter grade, A, B, C, D, or F. Additionally, in an exemplary embodiment the applicable letter grade may be assigned based upon what percentage of building residents fall into the high-risk category.

Additional functionality of the inventive system relates to credit reporting software module 140. Specifically, an advantage of particular embodiments of the present invention is that the system can report a resident's rent payment activity to the traditional credit bureaus. This allows the resident's credit score to be impacted positively as the resident establishes a history of on-time and in-full payments. In particular, as will be described in more detail with reference to FIG. 4, credit score reporting software module 140 compiles respective resident credit score updates in the form of industry-standard Metro 2 files based upon resident activity information. Credit score reporting module 140 periodically transmits the Metro 2 files to credit bureaus 120.

FIG. 1 further illustrates digital databases wherein data that is retrieved, calculated, and utilized are stored. Accounts digital database 150 includes, without limitation, information pertinent to the lease agreements for a given building and respective residents. This includes the date a lease began, the date the lease ends, the rent obligation, the day of the month that the rent is due, account balances, and past due balances. Transactions digital database 155 includes, without limitation, the dates rent invoices are dispatched to residents, the dates rent payments are made, and the amount of the payments. The persons digital database 160 includes, without limitation, identification information of each individual occupying a unit under lease. Lease details are stored in accounts digital database 150, as discussed. However, often there is more than one occupant in a given unit, and particular occupants may not be formally signatories to a lease. Persons digital database 160 includes identification information for all occupants, including name, email address, and mobile phone number, as examples.

FIG. 2 illustrates in more detail retrieving and storing resident activity information according to one exemplary embodiment of the present invention. In an exemplary embodiment resident activity information includes, without limitation, new lease information including occupants and terms, expiring lease information, move in and move out dates, billing activity, and resident rent payment activity.

In some instances, resident activity information data is input manually. This occurs when a property is not active with a property management software platform that can be automatically interacted with by system 105. FIG. 2 illustrates manual resident information software module 112, which facilitates this manual input. To accomplish manual resident activity input, a system administrator operates a system admin software application by way of admin browser user interface 205. The admin software application is made available by content delivery network (CDN) 210, which is a cloud-based content server.

Resident information software module 112 includes the raw resident activity data which may, for example, be provided as a comma separated value (.csv) file 215. The admin manually inputs the .csv file into system 105 by, for example, dragging and dropping file 215 into the admin app executing through admin browser user interface 205. This initiates file 215 being input into application programming interface (API) gateway 225.

API gateway 225 communicates with a plurality of software services that manipulate and store the resident activity information into the appropriate digital databases. More specifically, gateway 225 provides new lease and expiring lease information, as examples, to accounts software service 230, which stores information in accounts digital database 150. Similarly, gateway 225 provides billing and payment information, as examples, to transactions service 235, which stores information in transactions digital database 155. Additionally, gateway 225 provides new occupant information, as an example, to persons service 240, which stores information in persons digital database 160.

Resident activity information is also obtained in a more automated fashion by way of property management software module 114. More specifically, in certain cases, a property employs commercially available web and cloud-based software for managing the property. Example platforms include Entrata, Yardi, MRI, and RealPage. These platforms are represented in FIG. 2 by platforms 245-1 through 245-n. Platform software services 250-1 through 250-n interface platforms 245-1 through 245-n with gateway 225. System 105 periodically engages platforms 245-1 through 245-n through services 250-1 through 250-n, respectively, to retrieve resident activity information. Gateway 225 transmits the retrieved resident activity information to respective digital database services 230, 235, 240, 242, and 243 which subsequently store the appropriate data in respective digital databases 150, 155,160, 162, and 164.

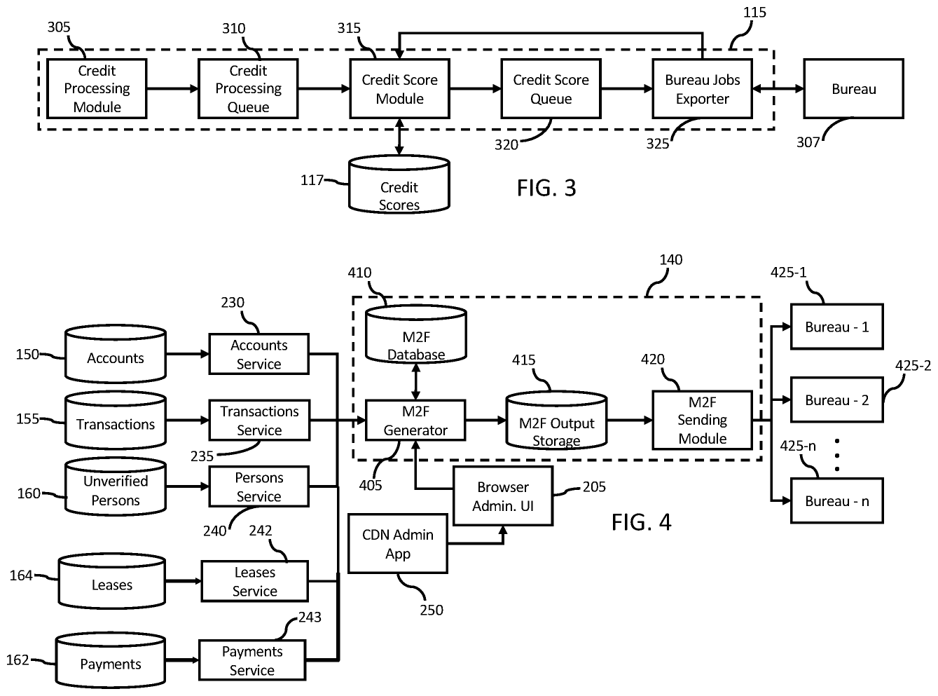

FIG. 3 illustrates retrieving and storing resident credit score information according to one exemplary embodiment of the present invention. FIG. 3 illustrates the detail and operation of credit score extraction software module 115. Credit processing module 305 periodically, as an example monthly, initiates resident credit scores retrieval from at least one traditional credit bureau 307.

Credit processing module 305 has access to accounts, transactions, and persons databases 150, 155, and 160, respectively. According to predetermined algorithms, credit processing module 305 compiles a superset list of resident identities that may require credit score updates. The superset list is stored in credit processing queue 310. Credit processing queue 310 is accessible to credit score module 315. Credit score module 315 determines which residents in the superset list require a credit score update. More specifically, credit score module 315 checks credit score digital database 117 for information including whether a resident's score has been updated within the last 30 days and whether a resident still occupies the property, or alternatively has moved out and is no longer of interest. Based on this information, as examples, credit score module 315 establishes a final list of residents requiring score updates. That list is stored in credit score queue 320.

Bureau jobs exporter 325 has access to credit score queue 320. Bureau job exporter 325 engages bureau 307 requesting transmission of current credit scores for the residents requiring score updates. Bureau 307 provides the scores for those residents for whom it has a record to bureau jobs exporter 325. Bureau job exporter 325 provides that data to credit score module 315, which updates credit scores database 117 accordingly.

FIG. 4 illustrates compiling resident credit score updates and providing resident credit score updates to credit bureaus according to one exemplary embodiment of the present invention. For each resident that has opted in, on a periodic basis the subsystem shown in FIG. 4 builds an industry standard Metro 2 credit score update file and provides that file to credit bureaus. This information is taken into account by the credit bureaus in connection with updating an individual's credit score.

More specifically, Metro 2 file (abbreviated M2F) module 405 has access to the databases 150, 155,160, 162, and 164 through respective services 230, 235, 240, 242, and 243. Either as initiated by an admin app served by CDN 250 and operating on browser admin user interface 205 or on an automated periodic basis, M2F module 405 compiles resident credit score update Metro 2 files. Module 405 obtains data customarily used for Metro 2 files and uses M2F database 410 as a working storage area for building the files. When the files are complete they are stored in M2F output storage 415. M2F sending module 420 accesses M2F storage 415 and transmits the files to respective credit bureaus 425-1 through 425-n. M2F module 410 and M2F sending module 420, and associated databases 410 and 415 are the sub-elements of credit score reporting software module 140 of FIG. 1.

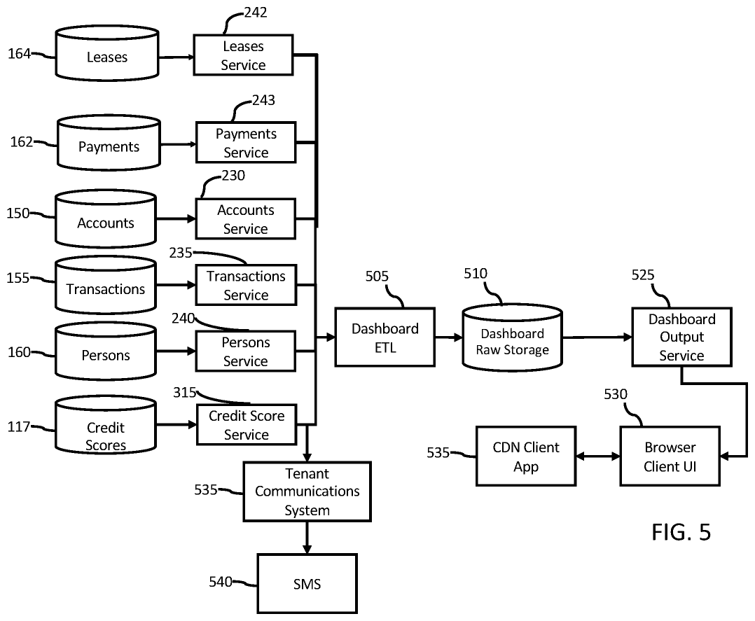

FIG. 5 is a block diagram illustrating aggregating resident risk score information to generate a property stability score and providing the property stability score and/or other relevant information for display on a client user interface, according to one exemplary embodiment of the present invention. FIG. 5 illustrates the details of processing and reporting software module 125 shown in FIG. 1. Specifically, module 125 comprises dashboard export transform load (ETL) 505, dashboard raw storage digital database 510, and dashboard output service 525.

In an exemplary embodiment, dashboard ETL 505 continuously or periodically monitors the data in databases 150, 155, 160, 162, and 164 and credit scores database 117 through their associated services 230, 235, 240, 242, 243, and 315 respectively, so that processing and reporting software module 125 can provide updated property stability scores and other information at any time upon request. Dashboard ETL 505 stores that data in dashboard raw storage digital database 510, which is accessible for processing by dashboard output service 525.

Dashboard output service 525 calculates individual resident risk tier levels. Additionally, dashboard output service 525 aggregates resident scores and calculates property stability scores, and the associated letter grade.

Browser-based client user interface 530 operates a client application that is available from and served by content delivery network (CDN) 535. Browser based client user interface 530 includes a dashboard screen that will be described in more detail with reference to FIGS. 6, 7, and 8.

Dashboard output service 525 serves to provide data to client user interface 530. This data can be provided upon request from the client application or provided periodically on an automated basis.

FIG. 5 additionally illustrates resident communication service 535. Resident communications service 535 has access to data in databases 150, 155, 160, 162, 164, and 117 through their associated services 230, 235, 240, 242, 243, and 315, respectively. Resident communications service 525 is configured to provide information to a resident user interface 540 which resides on resident device 135 shown in FIG. 1.

In an exemplary embodiment, resident communications service 535 communicates to residents via SMS messaging, illustrated by block 540, for a variety of purposes. As one example, when new occupants are admitted to the property, service 535 may generate an SMS message opt-in or opt-out query, allowing the occupant to opt out of rent reporting and credit score queries. As another example, in response to a resident request, service 535 may send by SMS message that resident's most recent credit score. As yet another example, at the request and scheduling of the property manager, service 535 may send promotional offers to multiple residents by SMS messaging. Additionally, for residents that are identified as high risk, information can be sent identifying lending sources that could support their financial needs.

FIG. 6 illustrates a client user interface display tailored for property owners according to one exemplary embodiment of the present invention. In an exemplary embodiment, screen 605 of FIG. 6 is displayed on browser-based client user interface 530 shown in FIG. 5. The information on screen 605 is delivered by dashboard output service 525 shown in FIG. 5.

Screen 605 comprises graphical representations of property stability score information, as well as other data of interest to the property manager and property owner. In the exemplary embodiment of FIG. 6, the property owner's property portfolio, Portfolio A, comprises three buildings A, B, and C, as indicated in drop-down menu 615 of sidebar 620.

In this example, graphical element 610 displays the letter score calculated for Portfolio A identified in drop-down section 615 of sidebar 620. Similarly, metrics displayed in the resident overview section 625 reflect the aggregate all three buildings A, B and C. Specifically, metric 630 is the total number of properties comprising Portfolio A. Metric 635 is the total number of rental units among those properties. Metric 640 is the percentage of those units that have opted-in to report rent activity. Metric 645 is the lowest credit score among reporting residents from the properties. Metric 650 is the average credit score among reporting residents. Metric 655 is the highest credit score among reporting residents. Metric 660 is the median credit score of reporting residents. Metric 665 is the number of residents who have, prior to enrolling in reporting, had no record of a credit score and since enrolling have established a credit score. And metric 670 is the percentage of reporting residents who have improved their credit score since participating in reporting rent payment activity.

Pie chart 675 provides a graphical representation of an x/100 property score that reflects the respective percentages of residents who fall into the various risk tiers described above.

Graphs occupying area 680 can selectively display trends over time of data including average resident credit score, total gross rent payments, and number of missed payments, selectable by drop-down menu 685. The data and graphical elements of screen 605 are a select number of examples that may be provided as part of dashboard 130 shown in FIG. 1 that is tailored for a property manager or property owner.

FIG. 7 illustrates a client user interface display tailored for lenders who have an interest in or a stake in one or more property portfolios owned by one or more particular property owners. In an exemplary embodiment, the screen 705 of FIG. 7 is displayed on browser-based client user interface 530 shown in FIG. 5. The information on screen 705 is delivered by dashboard output service 525 shown in FIG. 5.

Screen 705 comprises graphical representations of property stability score information, as well as other data of interest to an institutional lender. The dashboard tailored for a lender differs in part from that tailored for a property owner in that it includes and/or makes available information concerning more than one property owner portfolio as indicated by Portfolios A, B and C shown in sidebar 720. In this example, graphical element 710 displays the letter score calculated for the collection of properties comprising Portfolio A identified in drop-down section 715 of sidebar 720. Similarly, metrics displayed in the resident overview section 725 reflect the aggregate of all four property portfolios from different property owners. Specifically, metric 730 is the total number of properties comprising Portfolio A. Metric 735 is the total number of rental units among those properties. Metric 740 is the percentage of those units that have opted-in to report rent activity. Metric 745 is the lowest credit score among reporting residents from the properties. Metric 750 is the average credit score among reporting residents. Metric 755 is the highest credit score among reporting residents. Metric 760 is the median credit score of reporting residents. Metric 765 is the number of residents who have, prior to enrolling in reporting, had no record of a credit score and since enrolling have established a credit score. And metric 770 is the percentage of reporting residents who have improved their credit score since participating in reporting rent payment activity.

Pie chart 775 provides a graphical representation of an x/100 property score that reflects the respective percentages of residents who fall into the various risk tiers described above.

Graphs occupying area 780 can selectively display trends over time of data including average resident credit score, total gross rent payments, and number of missed payments, selectable by drop-down menu 785. The data and graphical elements of screen 705 are a select number of examples that may be provided as part of dashboard 130 shown in FIG. 1 that is tailored for a lender client.

FIG. 8 illustrates a client user interface display tailored for SMMLs. SMMLs have a particular interest in resident credit score values and credit score trends because those metrics significantly influence ESG. Consequently, in one exemplary embodiment, credit score metrics are emphasized in a SMML tailored display, as illustrated by FIG. 8. Furthermore, SMMLs have an interest or stake in a very large number of property portfolios, and therefore a preferred user interface tailored for SMMLs accommodates a large number of portfolios.

FIG. 8 is displayed on browser-based client user interface 530 shown in FIG. 5. The information on screen 805 is delivered by dashboard output service 525 shown in FIG. 5.

Screen 805 comprises a variety of metrics of interest to a SMML. In this example, overview section 810 is presented. Metrics are shown calculated for the collection of the properties managed by Asset Manager 1 highlighted in

sidebar 820. Specifically, metric 825 is the total number of properties managed by Asset Manager 1. Metric 830 is the total number of rental units among those properties. Metric 835 is the percentage of those units that are enrolled to report rent activity. Metric 840 is the number of residents who have, prior to enrolling in reporting, had no record of a credit score and since enrolling have established a credit score. Metric 845 is the percentage of reporting residents whose credit scores have improved since being enrolled in reporting. Metric 850 is the number of properties for which residents must affirmatively opt-in to reporting when taking a lease. Metric 855 is the number of properties for which residents are opted-in to reporting by default and must affirmatively opt-out if they wish not to participate.

Display region 860 presents further detail regarding resident credit score trends. Line 865 displays the minimum, average, and maximum credit score changes for all residents who are enrolled in reporting. Line 870 displays the minimum, average, and maximum credit score changes for all residents who had an established credit score prior enrolling in reporting.

Display region 875 presents additional detail regarding resident credit score trends. Specifically, line 880 displays metrics for the movement across credit score tiers for residents who had credit scores prior to enrolling in reporting. The credit tiers are, in an exemplary embodiment, the industry recognized FICO® credit score tiers.

Graphs occupying area 885 can selectively display trends over time of the various metrics shown in overview section 810, including for example change in average credit score over time. The data and graphical elements of screen 805 are a select number of examples that may be provided as part of dashboard 130 shown in FIG. 1 that is tailored for a SMML client.

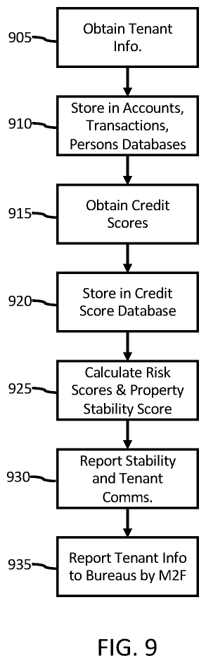

Turning now to FIG. 9, FIG. 9 is a flowchart illustrating a method of resident data management according to one exemplary embodiment of the present invention. The method illustrated by FIG. 9 is consistent with the foregoing description. Specifically, at step 905, the system obtains resident activity information. As discussed with reference to FIG. 2, the resident activity information could be entered manually, or automatically retrieved from property management software platforms. At step 910, the resident activity information is stored in the accounts, transactions, and persons digital databases.

At step 915, opt-in resident scores are obtained from at least one credit bureau, for example as described with reference to FIG. 3. At step 920 The credit scores are stored, for example in credit scores storage digital database 117.

At step 925, resident risk scores and property stability scores are calculated. At step 930 property stability scores and associated information are transmitted to a client dashboard. Additionally, information of interest to residents may be transmitted to respective resident user interfaces.

At step 935, Metro 2 credit score update files for opt-in residents are compiled and transmitted to one or more credit bureaus.

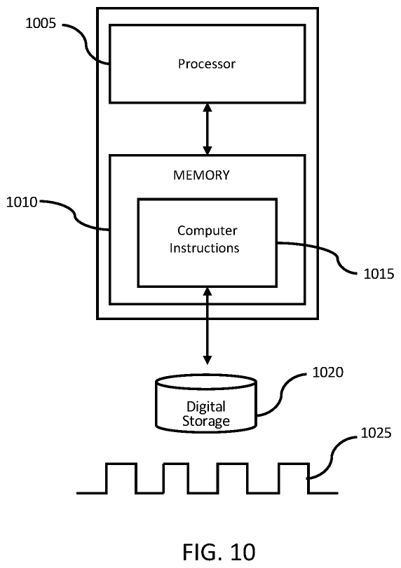

Turning to FIG. 10, FIG. 10 illustrates a non-transitory computer readable medium storing a program that, when executed by a computer system comprising one or more processors, causes the computer system to perform a method for resident data management consistent with above-described exemplary embodiments of the present invention. More specifically, FIG. 10 illustrates processor 1005, memory 1010, computer instructions 1015, computer readable storage medium 1020, and computer readable digital signal 1025.

In an exemplary embodiment of the present invention processor 1005 may be one or more processors operating on cloud-based servers, and/or a device operating the above-described admin app, and/or a device operating the above-described client app. Computer instructions 1015 are the computer instructions that, when executed by processors, perform a method for resident data management consistent with above-described exemplary embodiments of the present invention.

Computer instructions 1015 reside in memory 1010, which may be located on cloud-based servers, and/or a device operating the above-described admin app, and/or a device operating the above-described client app. Computer instructions 1015 may be read from computer readable storage medium 1020 and/or computer readable digital signal 1025 by processor 1005 and stored by processor 1005 permanently, semi-permanently, or temporarily, in memory 1010. In this exemplary embodiment, computer readable storage medium 1020 comprises solid state digital storage.

Consequently, what is provided by exemplary systems and methods according to the present invention is an efficient and effective system, methods, and computing capabilities that provide property managers, property owners, institutional lenders and SMMLs accurate, proactive visibility to, and reliable predictions of, rental income streams, as well as resident credit score metrics and trends. Moreover, the system, methods, and computing capabilities may integrate a resident's rent payment activities into that individual's credit bureau credit score. In this way, the resident is motivated to pay rent on time and in full, which benefits the resident, the property owner, institutional lenders and SMMLs. Additionally, the system, methods, and computing capabilities may identify residents at risk of not paying rent timely, and connect them with fair, low-interest lending sources to support their financial needs.

Some portions of this description describe the embodiments of the invention in terms of algorithms. These operations, while described functionally, computationally, or logically, are understood to be implemented by computer programs or equivalent electrical circuits, micro-code, or the like. The described operations may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to herein may include a single processor or may be implemented with architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially available operating systems and other known applications for purposes such as database management. These devices can also include other electronic devices, such as dummy terminals, virtual terminals, thin-clients, and other devices capable of communicating via a network.

Embodiments can utilize at least one network that would be familiar to those skilled in the art for supporting communications using any of a variety of commercially available protocols, such as TCP/IP, FTP, UPnP, NFS, and CIFS. The network can be, for example, a local area network, a wide-area network, a virtual private network, the internet, an intranet, an extranet, a public switched telephone network, an infrared network, a wireless network, or any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response to requests from user devices, such as by executing one or more Web applications that may be implemented as one or more scripts or programs written in any programming language, such as Java®, C, C# or C++ or any scripting language, such as Perl, Python, or TCL, as well as combinations thereof. The server(s) may also include database servers, including without limitation those commercially available from Oracle®, Microsoft®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element, or keypad) and at least one output device (e.g., a display screen, a display device, printer, or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed, and/or removable storage devices as well as storage media for temporarily and/or more permanently containing, storing, transmitting, and retrieving computer-readable information. The system and various devices also can include a number of software applications, modules, services, or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets, APIs, scripts, and the like), or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments and that many modifications and variations are possible.

The foregoing description of the embodiments of the invention has been presented for the purpose of illustration; it is not intended to be exhaustive or to limit the invention to the precise forms disclosed. The description and drawings are, accordingly, to be regarded in an illustrative rather than a restrictive sense. The language used in the specification has been principally selected for readability and instructional purposes. It is therefore intended that the scope of the invention be limited not by this detailed description and drawings, but rather by any claims that issue based on this application. It will, however, be evident that various modifications and changes may be made thereunto without departing from the broader spirit and scope of the invention as set forth in the claims.

What is claimed is:

1. A computer network implemented method for resident data management comprising the steps of:
periodically executing a scheduled retrieval of resident activity information for a plurality of residents over the internet from at least one property management software platform;
storing the resident activity information in at least a first digital database;
periodically executing a scheduled retrieval over the internet of resident credit score information for the plurality of residents;
storing the resident credit score information in a second digital database;
calculating resident credit score trend information based upon the resident credit score information;
calculating a resident risk score for each of the plurality of residents based upon the resident activity information and the resident credit score information;
aggregating the resident risk score information to generate a property stability score;
providing a browser-based client user interface;
in response to a first client user query requesting the property stability score, transmitting to the client user interface for display the property stability score;
in response to a second client user query requesting the resident credit score trend information, transmitting to the client user interface for display the resident credit score trend information;
compiling a plurality of resident credit score updates for each of the plurality of residents based upon the resident activity information;
periodically executing a scheduled transmission of the plurality of resident credit score updates to a credit bureau; and
transmitting to a respective one of the plurality of residents, in response to a respective resident credit score request, the respective resident credit score information.

2. The method of claim 1, further comprising the steps of:
providing a browser-based administrator application, the administrator application served by a content distribution network (CDN), and
manually inputting resident activity information through the browser-based administrator application.

3. The method of claim 1, wherein the resident activity information comprises a lease start date, a monthly rental amount, resident names, billing dates, and payment dates.

4. The method of claim 1, wherein the step of storing the resident activity information in at least the first digital database comprises storing the resident activity information in an accounts database and in a transactions database and in a persons database.

5. The method of claim 4, wherein the resident activity information stored in the transactions database comprises billing date information, payment date information, and payment amount information.

6. The method of claim 1, further comprising the steps of:
transmitting to a first resident an opt-in opt-out message;
receiving from the first resident an opt-out election; and
in response to receiving the opt-out election, removing the first resident from a list of credit score retrieval residents.

7. The method of claim 1, wherein the property stability score comprises a letter grade, and wherein the step of transmitting to the client user interface further comprises transmitting for display a percentage of residents falling within each of a plurality of risk level tiers, and transmitting for display an average credit score of property opt-in residents.

8. The method of claim 1, further comprising the step of transmitting loan availability information to selected residents.

9. The method of claim 1, wherein the step of calculating the resident risk score comprises categorizing the plurality of residents into four risk level tiers.

10. A computer network implemented method for resident data management comprising the steps of:
retrieving resident activity information for a plurality of residents over the internet from at least one property management software platform;
storing the resident activity information in at least a first digital database;
retrieving over the internet resident credit score information for the plurality of residents;
storing the resident credit score information in a second digital database;
calculating resident credit score trend information based upon the resident credit score information;
calculating a resident risk score for each of the plurality of residents based upon the resident activity information and the resident credit score information;
aggregating the resident risk score information to generate a property stability score;
providing a browser-based client user interface;
in response to a first client user query requesting the property stability score, transmitting to the client user interface for display the property stability score; and
in response to a second client user query requesting the resident credit score trend information, transmitting to the client user interface for display the resident credit score trend information.

11. The method of claim 10, further comprising the steps of:
providing a browser-based administrator application, the administrator application served by a content distribution network (CDN), and
manually inputting resident activity information through the browser-based administrator application.

12. The method of claim 10, further comprising the steps of:
compiling a plurality of resident credit score updates for each of the plurality of residents based upon the resident activity information; and
transmitting the plurality of credit score updates to a credit bureau.

13. The system of claim 12, further comprising transmitting to respective ones of the plurality of residents, in response to a respective resident credit score request, the respective resident credit score information.

14. The method of claim 10, further comprising the steps of:
transmitting to a first resident an opt-in opt-out message;
receiving from the first resident an opt-out election; and
in response to receiving the opt-out election, removing the first resident from a list of credit score retrieval residents.

15. The method of claim 10, wherein the property stability score comprises a letter grade, and wherein the step of transmitting to the client user interface further comprises transmitting for display a percentage of residents falling within each of a plurality of risk level tiers, and transmitting for display an average credit score of property opt-in residents.

16. The method of claim 10, further comprising the step of transmitting loan availability information to selected residents.

17. A non-transitory computer readable medium storing a program that, when executed by a computer system comprising one or more processors, causes the computer system to perform a method for resident data management comprising the steps of:
retrieving resident activity information for a plurality of residents over the internet from at least one property management software platform;
storing the resident activity information in at least a first digital database;
retrieving over the internet resident credit score information for the plurality of residents;
storing the resident credit score information in a second digital database;
calculating resident credit score trend information based upon the resident credit score information;
calculating a resident risk score for each of the plurality of residents based upon the resident activity information and the resident credit score information;
aggregating the resident risk score information to generate a property stability score;
providing a browser-based client user interface;
in response to a first client user query requesting the property stability score, transmitting to the client user interface for display the property stability score; and
in response to a second client user query requesting the resident credit score trend information, transmitting to the client user interface for display the resident credit score trend information.

18. The non-transitory computer readable medium storing the program of claim 17, wherein the program, when executed by the computer system comprising the one or more processors, further causes the computer system to:
compile a plurality of resident credit score updates for each of the plurality of residents based upon the resident activity information; and
transmit the plurality of credit score updates to a credit bureau.

19. The non-transitory computer readable medium storing the program of claim 17, wherein the property stability score comprises a letter grade, and wherein transmitting to the client user interface further comprises transmitting for display a percentage of residents falling within each of a plurality of risk level tiers, and transmitting for display an average credit score of property opt-in residents.

20. The non-transitory computer readable medium storing the program of claim 17 wherein the program, when executed by the computer system comprising the one or more processors, further causes the computer system to transmit loan availability information to selected residents.
